(19) United States
(12) Patent Application Publication
(10) Pub. No.: US 2007/0172063 A1
(43) Pub. Date: Jul. 26, 2007

(54) Out-Of-Band Authentication for Automated Applications ("BOTS")

(75) Inventors: Todd S. Biggs, Kirkland, WA (US); Shreedhar Madhavapeddi, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,637

(22) Filed: Jan. 20, 2006

(51) Int. Cl. H04K 1/10

(52) U.S. Cl. 380/255; 380/33

(57) ABSTRACT

A technique is disclosed for providing authentication for an automated application (e.g., a BOT) in a presence-based communication system, such as an instant messaging (IM) system or a voice over IP (VoIP) system. The presence-based communication system uses a first communication channel to conduct human-with-human communication and to conduct human-with-BOT communication. In addition, the presence-based communication system provides a second communication channel to initially set up the human-with-BOT communication in a secure manner.

### BACKGROUND

The Internet has fostered the growth of new communication systems, including instant messaging (IM) communication systems and voice over IP (VoIP) communication systems. These two communication systems may be regarded as specific types of “presence-based” communication systems. Generally, presence-based communication systems include functionality which allows communication participants to discover the availability of other participants. For instance, a typical IM communication system allows a user to create a contact list and then provides information regarding the availability of individual members in the list. Exemplary status indicators inform the user of whether a member is currently offline, online, online but “away,” and so forth.

In addition to human participants, a presence-based communication system may allow the user to add automated applications to her contact list. These automated applications are commonly referred to as robots, or more simply, BOTs. An automated application generally supplies information to the user or performs some other prescribed task associated with a particular application domain. For instance, a banking-related BOT may allow the user to query her account balances, transfer funds, and so on. An entertainment-related BOT may provide show times and reviews for currently playing movies, and so on. A BOT in a VoIP communication system may perform an audio-related function. To activate a BOT, the user can simply click on an icon that represents the BOT that appears in her contact list.

There are, however, potential shortcomings to the use of BOTs in a presence-based communication system. For example, the presence-based communication system may allow the user to interact with the BOT using the same communication channel that is used to communicate with human participants. Historically, presence-based communication systems have been applied to relatively informal communication among human participants. Therefore, the channel used by the presence-based communication system is not necessarily secure. As appreciated by the present inventors, this raises a concern in those cases in which the BOT may exchange relatively confidential information with the user. For example, a banking-related POT may provide confidential financial information pertaining to the user's account, and may even give the user the authority to transfer funds between accounts. One specific risk posed by non-secure BOT interaction is that someone with malicious intent (e.g., a “hacker”) may attempt to impersonate a legitimate user to gain access to a BOT, and thereby gain access to the user's confidential information through the BOT.

For at least the above-stated exemplary reasons, there is a need in the art for more satisfactory architectures and procedures for incorporating BOTs into a presence-based communication system.

### SUMMARY

A technique is disclosed for providing authentication for an automated application (e.g., a POT) in a presence-based communication system, such as, but not limited to, an instant messaging (IN) system, a voice over IP (VoIP) system, and so on. The presence-based communication system uses a first communication channel to implement the core communication tasks of the system, namely, to conduct human-with-human communication and human-with-BOT communication. In addition, the presence-based communication system provides a second communication channel to initially set up human-with-BOT communication in a secure manner.

According to one exemplary benefit, the use of the second, more secure, communication channel reduces the risk that an unauthorized individual can improperly interact with the BOT. This is because the presence-based communication system will not allow a user to access the BOT until the user has first established her legitimate right to interact with the BOT via the more secure second communication channel.

Still further features and attendant benefits of the authentication technique will be set forth below.

The subject matter set forth in this Summary section refers to exemplary manifestations of the invention, and hence does not limit the scope of the invention set in the Claims section.

### BRIEF DESCRIPTION OF THE DRAWINGS

FIG. 1 shows an exemplary presence-based communication system that interacts with a BOT.

FIG. 2 shows an exemplary user interface presentation that can be used by the system of FIG. 1, which allows a user to select a BOT listed in a contact list.

FIG. 3 shows another exemplary user interface presentation that can be used by the system of FIG. 1, which allows a user to authorize the presence-based communication system to interact with the BOT.

FIG. 4 shows another exemplary user interface presentation which allows a user to authorize the presence-based communication system to interact with the BOT.

FIGS. 5-7 show exemplary procedures for authorizing the presence-based communication system to communicate with the BOT.

FIG. 8 shows an exemplary computer environment for implementing aspects of the system of FIG. 5.

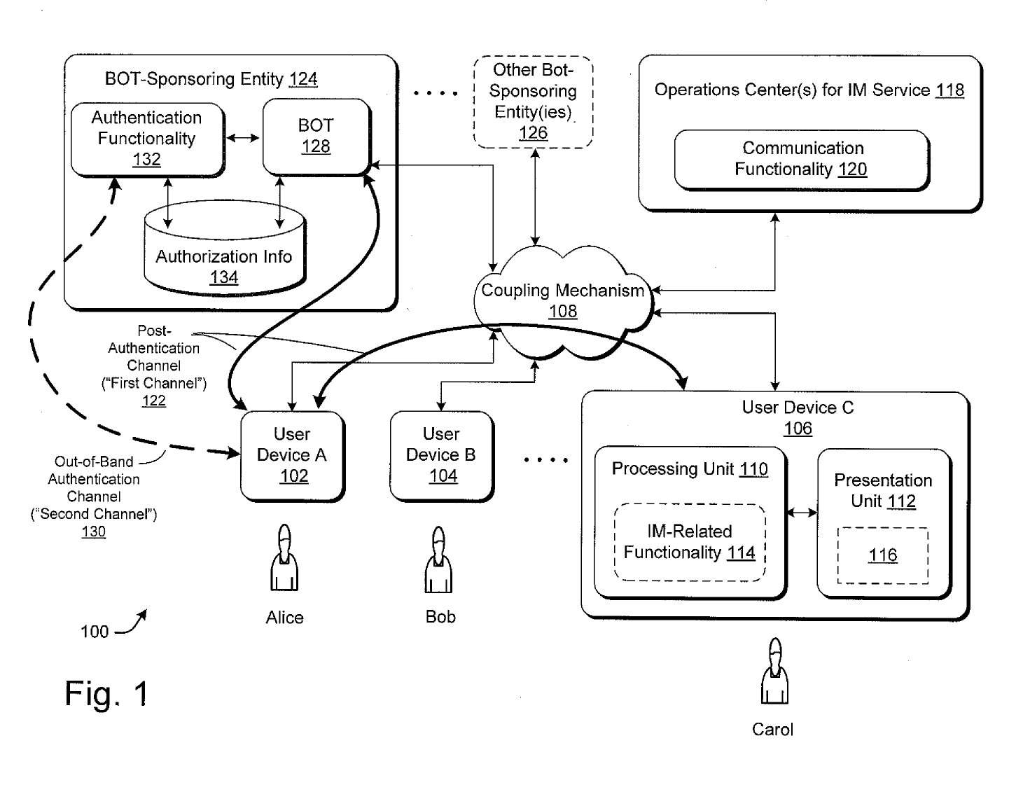

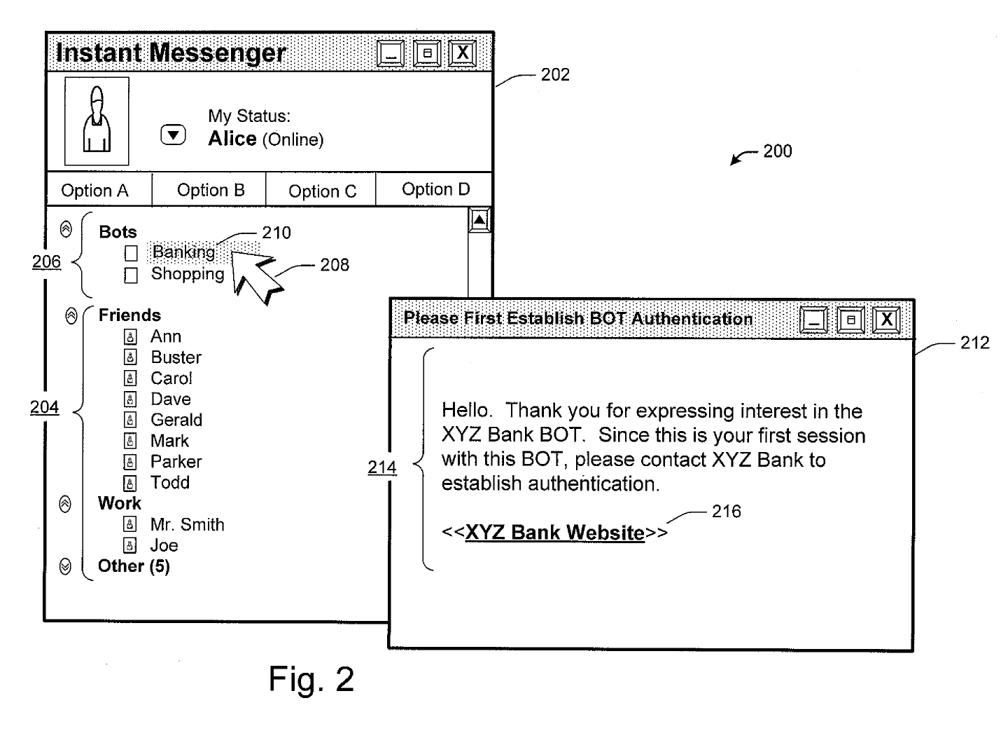

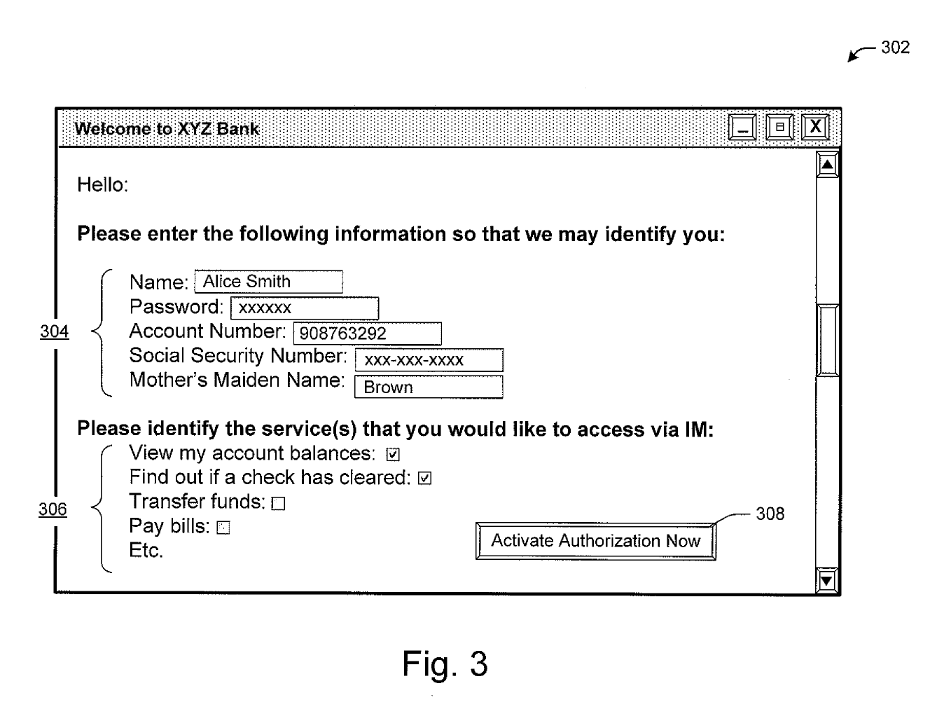

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The subject matter set forth herein pertains to functionality and techniques for allowing users to communicate with automated applications in a presence-based communication system in a secure manner.

A presence-based communication system refers to any kind of real-time or near-real-time communication system which allows participants to discover the availability of other participants in the system. A specific kind of presence-based communication system is an instant messaging (IM) communication session. To facilitate discussion, the authentication strategies will be primarily set forth in the context of this kind of presence-based communication system. But the principles described herein can be applied to any type of presence-based communication system, such as a voice over IP (VoIP) communication system, and so forth.

An automated application refers to any service that performs some function in an application domain, such as, without limitation, a banking-related application domain, any kind of e-commerce application domain, a stock trading application domain, any kind of search-related application domain, and so forth. A VoIP system may make use of audio-related automated applications. To facilitate explanation, the automated applications will be referred to herein as robots or more simply as BOTs.

This disclosure includes the following sections. Section A sets forth an exemplary presence-based communication system that provides secure communication with BOTs. Section B sets forth exemplary user interface presentations that allow users to interact with the system of Section A. Section C describes an exemplary manner of operation of the system of Section A. And section D describes an exemplary computer environment for implementing aspects of the system of section A.

A. Exemplary System (FIG. 1)

Generally, any of the functions described with reference to the figures can be implemented using software, hardware (e.g., fixed logic circuitry), manual processing, or a combination of these implementations. The term “logic, “module” or “functionality” as used herein generally represents software, hardware, or a combination of software and hardware. For instance, in the case of a software implementation, the term “logic,” “module,” or “functionality” represents program code (or declarative content) that performs specified tasks when executed on a processing device or devices (e.g., CPU or CPUs). The program code can be stored in one or more computer readable media.

More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, solid state, etc.). The term machine-readable media also encompasses transitory forms of representing information, including various hardwired and/or wireless links for transmitting the information from one point to another.

FIG. 3 shows one exemplary system 100 that can be used to implement the principles described herein. This system 100 corresponds to an instant messaging (IM) communication system, although, as stated above, the principles described herein can be applied to other presence-based communication systems, such as voice over IP (VoIP) communication systems. Briefly, an IM system allows a user to send text messages and other information to other available participants of the system in substantially real-time fashion. An “IM service” as used herein refers collectively to the various functions provided by the IM communication system.

The system 100 includes a collection of devices (102, 104, . . . 106) coupled together via a coupling mechanism 108. Each device (102, 104, . . . 106) can include any kind of equipment. In one exemplary case, the client devices (102, 104, . . . 106) can correspond to personal computer devices, personal digital assistant (PDA) devices, mobile phone devices, any kind of transportable or wearable computer devices, any kind of game console devices (such as Microsoft Corporation's Xbox™ game consoles), and so forth.

FIG. 1 shows the exemplary composition of representative client device C (106). This device 106 includes a processing unit 110 coupled to a presentation unit 112. The processing unit 110 comprises any data processing functionality for performing various ascribed tasks. The processing unit 110 can optionally include IM-related functionality 114 that allows the device 106 to participant in the IM service provided by the system 100. The presentation unit 112 provides any kind of interface to the processing unit 110. For instance, the presentation unit 112 can provide visual output, audio output, tactile output, any combination of such outputs, and so forth. In one preferred implementation, the presentation unit 112 can provide a user interface 116 that displays graphical information to the user.

The coupling mechanism 108 can comprise any mechanism or combination of mechanisms for coupling the components of the system 100 together. For instance, the coupling mechanism 108 can include any kind of network (or combination of networks), such as a wide area network (e.g., the Internet), an intranet, Digital Subscriber Line (DSL) network infrastructure, point-to-point coupling infrastructure, and so on. The coupling mechanism 108 can use or involve any kind of protocol or combination of protocols. In the case where one or more digital networks are used to disseminate information, the coupling mechanism 108 can include various hardwired and/or wireless links, routers, gateways, name servers, and so on (not shown).

Different users can operate different respective devices (102, 104, . . . 106) to exchange message with each other over the coupling mechanism 108. In one case, the IM communication system 100 can rely on an operations center 118 to exchange messages among devices (102, 104, . . . 106). To provide this capability, the operations center 118 may incorporate communication functionality 120. The communication functionality 120 can comprise one or more conventional switchboard devices (not shown) for exchanging messages among devices (102, 104, . . . 106). Alternatively, or in addition, the IM communication system 100 may rely on peer-to-peer (P2P) communication to exchange messages among devices (102, 104, . . . 106). Exemplary mechanisms for exchanging messages in an IM system are described, for example, in the following commonly assigned U.S. patent applications: U.S. application Ser. No. 10/611,575, entitled “Transport System for Instant Messaging,” filed on Jul. 1, 2003, and naming John S. Holmes et al. an inventors; U.S. application Ser. No. 10/987,396, entitled “Strategies for Peer-to-Peer Instant Messaging,” filed on Nov. 12, 2004, naming Carmen Zlateff et al. as inventors; and U.S. application Ser. No. 11/111,532, entitled “Peer-to-Peer Multicasting Using Multiple Transport Protocols,” filed on Apr. 21, 2005, naming Carmen Zlateff et al. as inventors.

In whatever manner implemented, the communication mechanism that is used by the IM communication system 100 to exchange messages among participants in the normal operation of the IM communication system 100 is referred as a first communication channel 122. For instance, the IM communication system 100 uses the first communication channel 122 to send a message from device A (102) to device C (106). As explained above in the Background section, the first communication channel 122 may or may not represent a secure communication channel.

In addition, the IM communication system may interact with one or more BOT sponsoring entities (124, . . . 126). As the name suggests, the BOT sponsoring entities (124, . . . 126) sponsor, administer, and/or implement one or more respective automated applications, referred to herein as robots or BOTs. For example, the BOT-sponsoring entity 124 provides BOT 128. In the illustrative and non-limiting examples which follow, the BOT sponsoring entity 124 specifically corresponds to a bank entity. The BOT 128 provided by tbis entity 124 allows users of the IM communication system 100 to perform various banking transactions, such as checking account balances, transferring funds between accounts, and so on.

In one implementation, the BOT 128 can be implemented as an application program and/or hardware logic rnnming on one or more server computers (not shown). For example, the bank can include server-side logic in its website which implements the BOT 128. In another implementation, the BOT 128 can be implemented by the IM service itself; such as by the operations center 118. In another implementation, the BOT 128 can be implemented by a combination of functionality provided by the bank and the IM service. In another implementation, the BOT 128 can be implemented by logic located within the client devices (102, 104, . . . 106). Still other implementations are possible.

A user can communicate with a BOT in a manner analogous to communication with another human participant. Namely, as will be discussed in the next section, the user can create a contact list that identifies entities with which the user may communicate. Some of these entities may represent human participants, while other entities may represent BOTs. To initiate a conversation with an available human participant, the user may click on that person's name in her contact list. Similarly, to initiate a conversation with the BOT 128 (which is typically, by default, always available), the user may click on the name of that BOT 128 in her contact list. Thereafter, the user can exchange information with the BOT 128 and perform various transactions. As indicated in FIG. 1, the IM communication system 100 uses the above-mentioned first communication channel 122 to allow the user devices (102, 104, . . . 106) to communicate with the BOT 128. This communication channel 122 is the same mechanism used to conduct human-with-human communication, for example, between device A (102) and device C (106).

However, as a preliminary step to communicating with the BOT 124 over the first communication channel 122, the IM communication system 100 requires a user to first authorize such communication using a second communication channel 130. The second communication channel 130 is typically more secure than the first communication channel 122 (although not necessarily so). For instance, the second communication channel 130 may employ any type of network security provision, such as Secure Sockets Layer (SSL) technology, and so forth. The secure second channel 130 can also be implemented by other kinds of communication routes. For instance, in other cases, the user can establish authorization through: Short Message Service (SMS); Email; a telephone conversation (with a bank operator); mail; courier; a gaming network, and so on. The second communication channel 130 shown in FIG. 1 can represent any of these communication paths. No limitation is placed on the nature of the secure second communication channel 130, except that it differs in one more respects from the first communication channel 122.

In whatever manner implemented, the secure second communication channel 130 better ensures that a hacker cannot improperly gain access to and interact with the BOT 128. This is because, as a threshold to communicating with the BOT 128, any user must first interact with the BOT 128 using the second communication channel 130. Since the second communication channel 130 itself is secure (or at least different than the first communication channel 122), this preliminary authorization protocol reduces the chances that the hacker can improperly gain access to the BOT 128.

The BOT-sponsoring entity 124 includes various modules for performing the above-described operations. First, the BOT-sponsoring entity 124 can include authentication functionality 132 for authorizing user-with-BOT communication. As shown, the user interacts with the authentication functionality 132 using the second communication channel 130, but after authentication, the user-with-BOT communication takes place over the first communication channel 122. The authentication functionality 132 can be implemented by logic associated with a third party (e.g., the bank) that is is entirely separate from the IM service, by the IM service alone, by a combination of third party functionality and IM service functionality, and so on. In one case, the authentication functionality 132 and the BOT 128 are provided at the same location (e.g., at a Bank's server-side website functionality). In another case, the authentication fuctionality 132 and the BOT 128 are provided at different locations.

In one case, the authentication functionality 132 can be implemented as an application that provides a series of graphical user interface presentations to the user. As will be described in the next section, the purpose of the user interface presentations is to solicit enough information from the user to establish the identity of the user, and hence, the right of the user to interact with the BOT 128. In another case, the authentication functionality 132 can be implemented as an application that can be accessed by telephone, which solicits the user to provide the required information via a fully automated dialogue. In another case, the authentication functionality 132 represents any communication mechanism that enables the user to talk to a human operator associated with the BOT-sponsoring entity 124. The authentication functionality 132 can also be implemented using hybrid mechanisms. For instance, the authentication functionality 132 can be implemented as a fully automated telephone message exchange, but may also allow the user to speak to a human operator at various junctures of the authorization process.

The authentication functionality 132 can rely on user information stored in one or more data stores 134. The user information may comprise data pertaining to the user that has been previously stored by the BOT-sponsoring entity 124. For instance, in the case where the BOT-sponsoring entity 124 corresponds to a bank, the bank may have previously collected information that uniquely identifies the user, such as the user's name, password(s), social security number, address, and so forth. The bank may have also recorded the user's answer to one or more authentication questions, such as “What is your mother's maiden name,” or “What is your favorite color,” etc. The authentication functionality 132 can perform authentication by asking the user to repeat the above-identified information over the second communication channel 130. If the user provides the correct information (meaning that the newly input information matches the previously stored information), then the user passes the authentication test. The authentication functionality 132 can also perform authentication by consulting other sources of information pertaining to the user, such as any kind of directory data store, any kind of credit check data store, any kind of law enforcement data store, and kind of risk analysis engine, and so forth.

The end result of the authentication, if successful, is to create authentication information. The authentication information establishes the right of the user to access the BOT 128 via the first communication channel 122. This authentication information can be stored in the data store 134 or some other data store (not shown). In one case, for instance, the authentication information can take the following generic form: a user X, who is using an IM address Y, is allowed to access BOT Z. In one case, for instance, the authentication information can map account ID information into messenger address information, giving a certain messenger identity the authority to access certain accounts. This information can be stored as one or more entries in a table within the data store 134.

Following authentication, the user can then access and successfully interact with the BOT 128 via the first communication channel 122. In other words, when the user subsequently clicks on the name of the BOT in her contact list, the user will be immediately granted access to the BOT 128. The authentication functionality 132 can grant such authorization by checking the information stored in the data store 134, e.g., by determining whether the user X, having IM address Y, is pre-registered to interact with the BOT Z.

In another implementation, following authentication, the authentication functionality 132 can additionally require the user to enter one or more passwords or perform some other security operation to gain access to the BOT 128 for each use, even though the user has already established her right to communicate with BOT through the second communication channel 132

In another implementation, the authentication functionality 132 can require the user to periodically repeat the authentication procedure that takes place over the second communication channel 130. Indeed, in one variant of this motif, the authentication functionality 132 can require the user to perform authentication over the second channel 130 each time that the user wants access the BOT 128. Or the authentication functionality 132 can require the user to perform per-transaction second-channel-authentication for only transactions that are deemed to present high security risks, such as the transfer of funds between accounts, and so forth.

As a final note, FIG. 1 shows that a user, Alice, uses representative device A (102) to communicate with other entities in the system 100 in the normal (i.e., post-authentication) operation of the system 100, and also uses the device A (102) to communicate with the authentication functionality 132. However, a user can use a first device to conduct normal post-authentication communication and a second device (not shown) to communicate with the authentication functionally 132.

B. Exemplary User Interface Presentations (FIGS. 2-4)

As indicated in FIG. 1, any of the user devices (102, 104, . . . 106) can provide a user interface 116. The user interface 116 allows the user to interact with other human participants of the IM network 100. The user interface 116 can also allow the user to interact with the BOTs (124, . . . 126). The user interface 116 can be implemented by logic stored at the device level, at the network level, or ata combination of the device level and network level.

The user interface 116 provides one or more user interface presentations. The user interface presentations can provide any kind of visual and/or audio content. Users can interact with the user interface presentations using various input mechanisms, such as keyboard, mouse device, track ball, touch pad, touch screen, and so forth.

FIGS. 2-4 show exemplary user interface presentations that a user can use to interact with the IM communication system 100. The reader will appreciate that the style, organization and content of these user interface presentations can be changed to suit different technical and business environments. For instance, where the device that interacts with the IM communication system 100 is a mobile phone or other reduced-size device, the information presented in the user interface presentations can be suitably condensed.

To begin with, FIG. 2 shows a user interface presentation 200 provided to a user, Alice, who operates device 102 of FIG. 1. The user interface presentation 200 includes a first user interface panel 202 that lists the entries of Alice's contact list. The contact list includes a set of entries 204 that identify human participants with whom Alice may communicate via text messaging or other form of information exchange. The contact list also includes another set of entries 206 that identify BOTs with which Alice may interact. Although not shown, the user interface panel 202 can provide information that indicates whether each of the entries in Alice's contact list is available or unavailable (and if unavailable, the reason why the entry is unavailable). In one implementation, BOTs are assumed to be usually available.

The user, Alice, can initiate a conversation with any entry in the contact list by pointing to and clicking on that entry, or performing another kind of selection action. For instance, in the scenario of FIG. 2, Alice has moved her cursor 208 to an entry 210 corresponding to the banking-related BOT 128 of FIG. 1. Clicking on this entry 210 will therefore activate the banking BOT 128.

Assume that the user, Alice, has not yet established her night to communicate with the BOT 128 via the first communication channel 122. In this case, clicking on the BOT entry 210 can invoke the presentation of another user interface panel 212. This user interface panel 212 includes a message 214. The message 214 instructs the user that she must first contact the bank to establish her right to communicate with the BOT 128 using the first communication channel 122. In this particular exemplary scenario, the message 214 includes a link 216 which redirects the user to a web site administered by the bank.

FIG. 3 shows a scenario in which the user has clicked on link 216 (of FIG. 2). This prompts the authentication functionality 132 of the bank to provide one or more user interface presentations, such as exemplary user interface presentation 302.

The user interface presentation 302 can solicit various types of information from the user. In a first series of input prompts 304, the user interface presentation 302 asks the user to provide various information items that identify the user (e.g., the hypothetical user Alice Smith). Exemplary information items that can be collected include: the user's name; the user's password(s); the user's account number(s); the user's social security number, and so forth. In addition, the user interface presentation 302 can ask the user to answer one or more questions that someone who might be impersonating the user is unlikely to know. For instance, as shown in FIG. 3, the user interface presentation 302 might ask the user to provide her mother's maiden name, etc. The authentication functionality 132 can perform authentication using the information collected in the series is of prompts 304 by comparing the input information against information that the user might have supplied to the bank in advance (e.g., when the user initially set up her account at the bank).

In a second series of prompts 306 ask the user to indicate what specific actions that the BOT 128 is authorized to perform when the user accesses the BOT 128 over the first communication channel 122. Some of these actions may pose a greater risk than others. Thus, the user can reduce the risk by only authorizing lower-risk transactions. For instance, in this case, the user has authorized the bank BOT 128 to provide various balance information and check clearance information over the first communication channel 122. But the user has not authorized the BOT 128 to transfer funds for the user over the first communication channel 122.

Although not shown, the user interface presentation 302 can give the user the opportunity to speak with a human operator of the bank if the user is having difficulty interacting with the user interface presentation 302, or if the user has any questions which are not addressed by the user interface presentation 302.

The graphical exchange of authentication information in the scenario shown in FIG. 3 is merely exemplary. The user can engage in many other types of interaction with the bank to establish her right to communicate with the BOT 128. For instance, the authentication functionality 132 may solicit information from the user via verbal exchange, implemented through an exchange with an automated application, and/or an exchange with a human operator, and so forth.

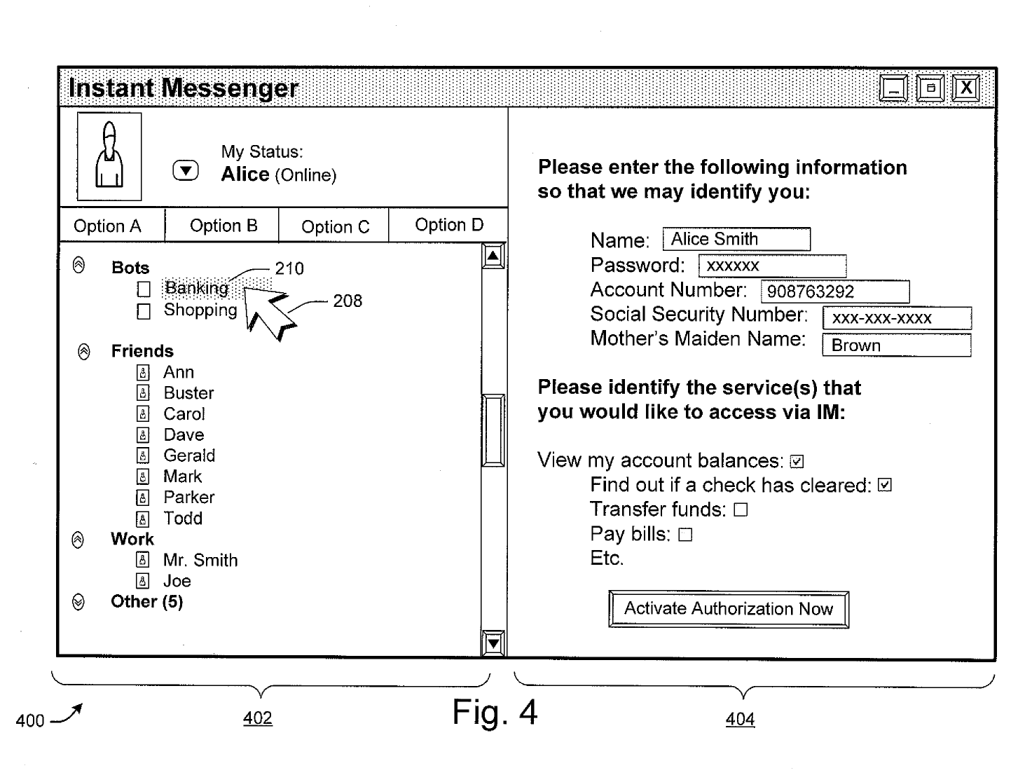

The final scenario of FIG. 4 shows an alternative manner in which the bank can solicit information from the user. Namely, for frame of reference, FIGS. 2 and 3 show a scenario in which the IM user interface framework is separate from the BOT-related authentication functionality. In this scenario, the user is directed to an entirely new user interface presentation (i.e., presentation 302) when the user clicks on the bank BOT entry 210 in the contact list for the first time. By contrast, FIG. 4 shows a scenario in which an IM user interface framework incorporates the BOT-related authentication functionality as part thereof In this scenario, the user can conduct the authentication procedure within the IM user interface framework (without being directed to an entirely distinct authentication presentation).

More specifically, FIG. 4 shows a user interface presentation 400 that includes a first portion 402 which shows the user's contact list. The user interface presentation 400 includes a second portion 404 which provides an interface to the authentication functionality 132. Namely, the second portion 404 duplicates the function of the user interface presentation 302 of FIG. 3. The specific split-panel presentation style shown in FIG. 4 is merely one example, the point being that the authentication information can be collected in the context of any IM-based user interface presentation framework.

In one case, the bank continues to dictate the functional and/or appearance-related aspects of the second portion 404. In another case, the IM service can dictate, in whole or in part, the functional and/or appearance-related aspects of the second portion 404. In either case, the second portion 404 still provides an interface to the authentication functionality 132 over the secure second communication channel 130.

Still other user interface mechanisms are possible for implementing the principles described herein. Also, the user may establish authentication using different procedures. For instance, in the scenarios discussed above, the user first adds the BOT 128 to the contact list, and then conducts the authentication procedure. In another case, the user can first perform the authentication procedure and then add the BOT 128 to the contact list. In this latter case, the IM service can even prevent the user from adding the BOT 128 to the contact list until the user first performs the authentication procedure.

C. Exemplary Processes

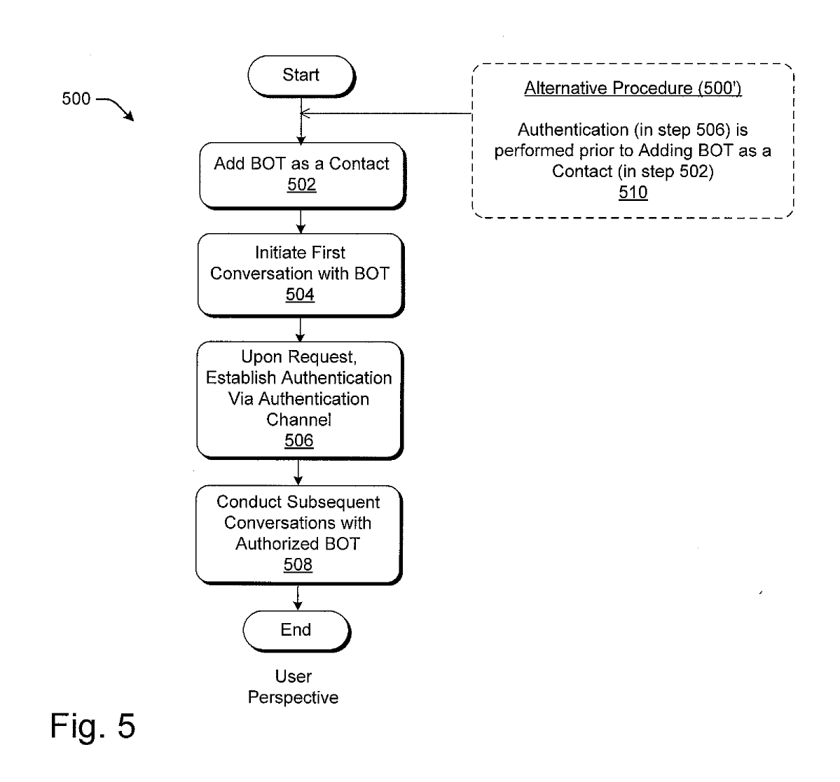

FIGS. 5-7 show procedures that explain an exemplary manner of operation of the system 100 shown in FIG. 1. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure. As the exemplary manner of operation of the system 100 has already been set forth in the context of the discussion of FIG. 1, this section will serve primarily as a review.

To begin with, FIG. 5 shows a procedure 500 that depicts the operation of the system 100 from the standpoint of a user who interacts with the system 100.

In step 502, the user adds the BOT 128 as a contact to her contact list. This results, for example, in the bank-related BOT entry 210 being added to the contact list, as shown in FIG. 2 and FIG. 4.

In step 504, the user initiates a first conversation with the BOT 128.

In step 506, the user is redirected to the authentication functionality 132 which performs an authentication procedure. This is because the user has not previously established her right to communicate with the BOT 128 over the first communication channel 122. In this step, the user establishes her authorization to interact with the BOT 128, e.g., by answering the questions shown in FIGS. 3 or 4. This authentication procedure takes place over the second communication channel 130.

In step 508, subsequent to authentication, the user can properly interact with the BOT 128 via the first communication channel 122. In the case of the bank BOT 128, this operation can involve reviewing account balances, transferring funds, and so forth.

Step 510 represents a variation of the procedure 500 (to provide alternative procedure 500′). In step 510, the user performs the authentication operation prior to adding the BOT 128 as a contact in the contact list. The user can perform this operation by independently accessing a website associated with the BOT-sponsoring entity 124, or through some other mechanism. Or the user can access the BOT-sponsoring entity 124 through a user interface framework provided by the IM service itself In this scenario 500′, the user can interact with the BOT 128 immediately after adding it to the contact list (since the user has already performed the authentication operation).

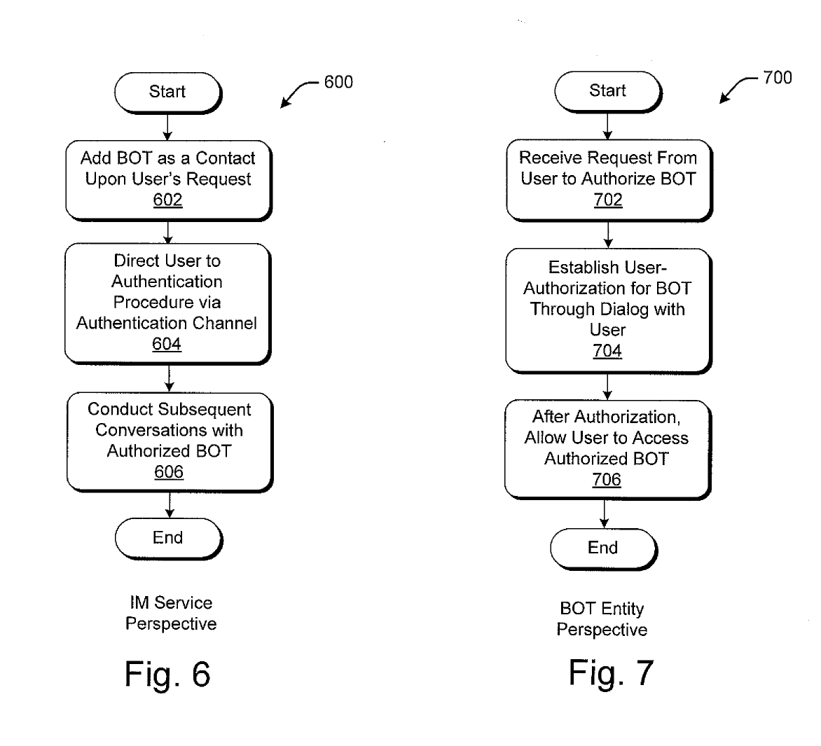

FIG. 6 is a procedure 600 that depicts the operation of the system 100 from the perspective of the IM service

In step 602, the IM service adds the BOT 128 as a contact in the user's contact list.

In step 604, when the user activates the BOT 128 for the first time, the IM service directs the user to authentication functionality which executes an authentication procedure (if, in fact, the user has not already authenticated the BOT 128 through other means). This authentication procedure takes place over the second communication channel 130.

In step 606, subsequent to authentication, the IM service allows the user to interact with the BOT 128 via the first communication channel 122.

FIG. 7 is a procedure 700 that depicts the operation of the system 100 from the standpoint of the BOT-sponsoring entity 124.

In step 702, the BOT-sponsoring entity 124 receives a request from the user (or is indirectly from the IM service) that indicates that the user wishes to establish the right to communicate with the BOT 128 via the IM service.

In step 704, the BOT-sponsoring entity 124 can establish the required authentication by conducting any kind of dialog with the user. In this dialogue, the BOT-sponsoring entity 124 solicits and collects the kinds of information items shown in FIGS. 3 and 4.

In step 706, subsequent to authentication, the BOT-sponsoring entity 124 allows the user to interact with the BOT 128 via the first communication channel 122.

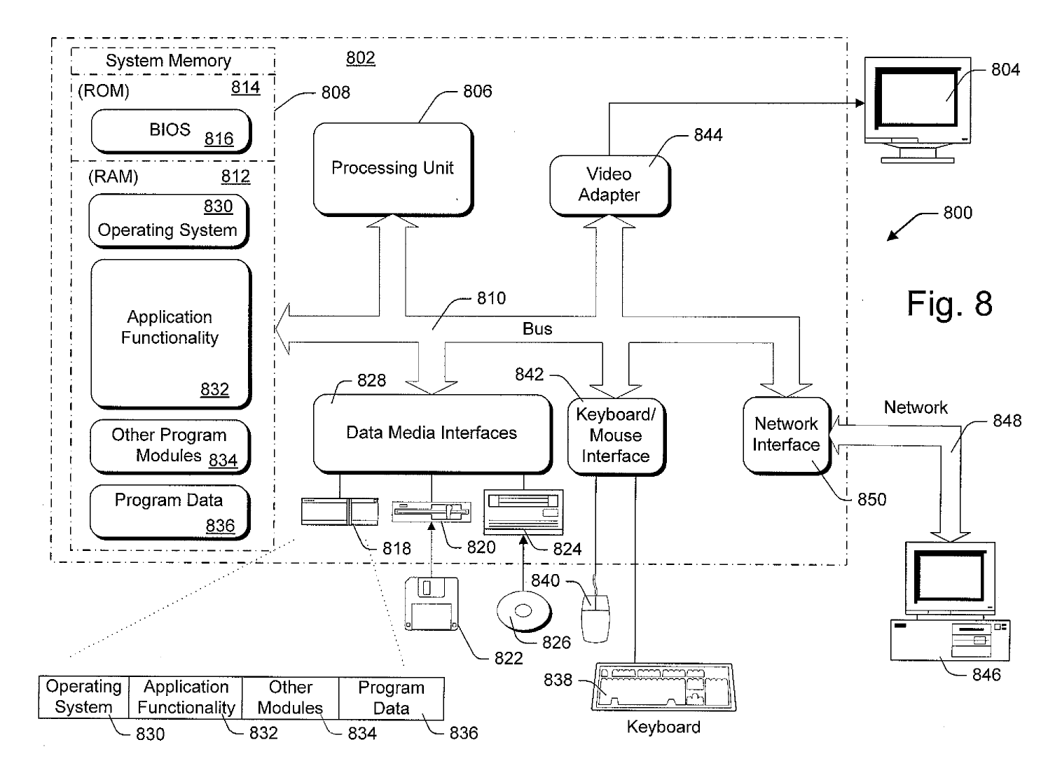

D. Exemplary Computer Environment (FIG. 8)

FIG. 8 provides information regarding an exemplary computer environment 800 that can be used to implement any of the processing functions described in the proceeding sections. For instance, the computer environment 800 can be used to implement any one of the user devices (102, 104, . . . 106), any aspect of the operations center 118, any aspect of the BOT-sponsoring entity 124 (including the BOT 128 itself and/or the authentication functionality 132), and so on.

The computing environment 800 includes a general purpose or server type computer 802 and a display device 804. However, the computing environment 800 can include other kinds of computing equipment. For example, although not shown, the computer environment 800 can include hand-held or laptop devices, set top boxes, game consoles, mainframe computers, etc. Further, FIG. 8 shows elements of the computer environment 800 grouped together to facilitate discussion. However, the computing environment 800 can employ a distributed processing configuration. In a distributed computing environment, computing resources can be physically dispersed throughout the environment.

Exemplary computer 802 includes one or more processors or processing units 806, a system memory 808, and a bus 810. The bus 810 connects various system components together. For instance, the bus 810 connects the processor 806 to the system memory 808. The bus 810 can be implemented using any kind of bus structure or combination of bus structures, including a memory bus or memory controller, a peripheral bus, an accelerated graphics port, and a processor or local bus using any of a variety of bus architectures.

Computer 802 can also include a variety of computer readable media, including a variety of types of volatile and non-volatile media, each of which can be removable or non-removable. For example, system memory 808 includes computer readable media in the form of volatile memory, such as random access memory (RAM) 812, and non-volatile memory, such as read only memory (ROM) 814. ROM 814 includes an input/output system (BIOS) 816 that contains the basic routines that help to transfer information between elements within computer 802, such as during start-up. RAM 812 typically contains data and/or program modules in a form that can be quickly accessed by processing unit 806.

Other kinds of computer storage media include a hard disk drive 818 for reading from and writing to a non-removable, non-volatile magnetic media, a magnetic disk drive 820 for reading from and writing to a removable, non-volatile magnetic disk 822 (e.g., a “floppy disk”), and an optical disk drive 824 for reading from and/or writing to a removable, non-volatile optical disk 826 such as a CD-ROM, DVD-ROM, or other optical media. The hard disk drive 818, magnetic disk drive 820, and optical disk drive 824 are each connected to the system bus 810 by one or more data media interfaces 828. Alternatively, the hard disk drive 818, magnetic disk drive 820, and optical disk drive 824 can be connected to the system bus 810 by a SCSI interface (not shown), or other coupling mechanism. Although not shown, the computer 802 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 802. For instance, the readable media can store the operating system 830, application-specific functionality 832, other program modules 834, and program data 836.

The computer environment 800 can include a variety of input devices. For instance, the computer environment 800 includes the keyboard 838 and a pointing device 840 (e.g., a “mouse”) for entering commands and information into computer 802. The computer environment 800 can include other input devices (not illustrated), such as a microphone, joystick, game pad, satellite dish, serial port, scanner, card reading devices, digital or video camera, etc. Input/output interfaces 842 couple the input devices to the processing unit 806. More generally, input devices can be coupled to the computer 802 through any kind of interface and bus structures, such as a parallel port, serial port, game port, universal serial bus (USB) port, etc.

The computer environment 800 also includes the display device 804. A video adapter 844 couples the display device 804 to the bus 810. In addition to the display device 804, the computer environment 800 can include other output peripheral devices, such as speakers (not shown), a printer (not shown), etc.

Computer 802 operates in a networked environment using logical connections to one or more remote computers, such as a remote computing device 846. The remote computing device 846 can comprise any kind of computer equipment, including a general purpose personal computer, portable computer, a server, etc. Remote computing device 846 can include all of the features discussed above with respect to computer 802, or some subset thereof.

Any type of network 848 can be used to couple the computer 802 with remote computing device 846, such as the WAN 402 of FIG. 4, a LAN, etc. The computer 802 couples to the network 848 via network interface 850 (e.g., the interface 416 shown in FIG. 4), which can utilize broadband connectivity, modem connectivity, DSL connectivity, or other connection strategy. Although not illustrated, the computing environment 800 can provide wireless communication functionality for connecting computer 802 with remote computing device 846 (e.g., via modulated radio signals, modulated infrared signals, etc.).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for providing authentication for an automated application accessible through a presence-based communication system, comprising:
providing, authorization to enable the automated application to interact with the user through a first communication channel, wherein the authorization is performed using a second communication channel which is different from the first communication channel; and
permitting the user, subsequent to the authorization, to communicate with the automated application using the first communication channel.

2. The method of claim 1, wherein the presence-based communication system is an instant messenger system.

3. The method of claim 1, wherein the presence-based communication system is a voice-over-IP system.

4. The method of claim 1, further comprising, before or after the authorization, adding the automated application as a contact in the presence-based communication system.

5. The method of claim 1, wherein the second communication channel is more secure than the first communication channel.

6. The method of claim 1, wherein the first communication channel is administered by an entity associated with the presence-based communication system, and the second communication channel is administered by an entity associated with the automated application.

7. The method of claim 1, wherein the automated application is a banking-related application.

8. The method of claim 1, wherein the automated application is an e-commerce related application.

9. One or more computer readable media containing machine-executable instructions for implementing the method of claim 1.

10. A system for providing authentication, comprising:
an automated-application;
a presence-based communication system, including a first communication channel for communicatively coupling participants of the presence-based communication system; and
a second communication channel for use in establishing authorization for the automated-application to communicate with a user through the first communication channel.

11. The system of claim 10, wherein the presence-based communication system is an instant messenger system.

12. The system of claim 10, wherein the presence-based communication system is a voice-over-IP system.

13. The system of claim 10, wherein the automated application is a contact in the presence-based communication system.

14. The system of claim 10, wherein the second communication channel is more secure than the first communication channel.

15. The system of claim 10, wherein the first communication channel is administered by an entity associated with the presence-based communication system, and the second communication channel is administered by an entity associated with the automated application.

16. The system of claim 10, wherein the automated application is a banking-related application.

17. The system of claim 10, wherein the automated application is an e-commerce related application.

18. A method for providing authentication for an automated application that is accessible through a presence-based communication system, comprising:
adding the automated application as a contact in the presence-based communication system;
receiving a user's initial activation of the automated application; and
directing the user to establish authorization to use the automated application prior to using the automated application, wherein the presence-based communication system communicates with the automated application using a first communication channel, and wherein authorization takes place using a second communication channel, and wherein the second communication channel is more secure than the first communication channel

19. The method of claim 18, further comprising:
receiving the user's authorization of the automated application using the second communication channel; and
permitting the user, subsequent to the authorization, to communicate with the automated application using the first communication channel.

20. One or more computer readable media containing machine-executable instructions for implementing the method of claim 18.
